(19) United States
(12) Patent Application Publication
(10) Pub. No.: US 2024/0223288 A1
(43) Pub. Date: Jul. 4, 2024

(54) A METHOD FOR RECOGNISING AN INCORRECTLY OPERATING ANTENNA IN A COMMUNICATION NETWORK

(71) Applicant: Elisa Oyj, Helsinki (FI)

(72) Inventors: Riku ERTIMO, Helsinki (FI); Risto ALESTALO, Helsinki (FI)

(21) Appl. No.: 18/564,114

(22) PCT Filed: May 23, 2022
(86) PCT No.: PCT/FI2022/050350

§ 371 Date: Nov. 27, 2023

(30) Foreign Application Priority Data
May 31, 2021 (FI) 20215638

(51) Int. Cl. H04B 17/17; H01Q 3/26; H04B 7/0426; H04W 24/10

(52) U.S. Cl. CPC H04B 17/17; H01Q 3/267; H04B 7/043; H04W 24/10

(57) ABSTRACT

A computer implemented method for recognizing an incorrectly operating beamforming antenna that serves a sector of a cell of a communication network. The method comprises obtaining samples comprising coordinates of locations within said sector linked with detected information identifying respective beams that served said locations, determining whether correct beams served correct locations, and providing output information indicating whether the target beamforming antenna is operating incorrectly based on said determination.

### TECHNICAL FIELD

The present disclosure generally relates to performance analysis of a communication network. The disclosure relates particularly, though not exclusively, to a method for recognition of an incorrectly operating antenna in a cell of a communication network.

### BACKGROUND

This section illustrates useful background information without admission of any technique described herein representative of the state of the art.

Cellular communication networks are complex systems comprising a plurality of cells serving users of the network. In order for a communication network to operate as intended and to provide a planned quality of service, cells of the communication network need to operate as planned.

Cells of communication networks are provided with transmitting and receiving antennas which may be placed at dedicated antenna towers, on the roof of various buildings or at similar locations. Instead of omnidirectional antennas it is typical to use sector antennas serving only a sector. For example, three sector antennas divided at angular separation of 120 degrees may be used to cover a whole 360 degrees area of a cell.

In advanced networks, the sector antennas are implemented as beamforming antennas. The beamforming antennas are capable of producing narrow beams within the sector they are serving to further improve the service provided to the users. The correct operation of beamforming antennas require that the antennas are configured correctly. However, during configuration, there are a plurality of output ports in remote radio units that must be connected by cables to respective antenna ports manually, and sometimes the cables end up being connected incorrectly. Wrong cabling is typically caused by a human error, but in some cases also instructions have been insufficient causing systematic errors.

When beamforming is activated and if antenna configuration is performed incorrectly, antenna patterns are not correct, leading to capacity and quality losses.

Now a new approach for recognizing such incorrectly operating beamforming antennas is provided.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect of the present invention, there is provided a computer implemented method for recognizing an incorrectly operating beamforming antenna that serves a sector of a cell of a communication network, the method comprising:
obtaining samples comprising coordinates of locations within said sector linked with detected information identifying respective beams (of the beamforming antenna) that served said locations;
determining whether correct beams served correct locations; and providing output information indicating whether the beamforming antenna is operating incorrectly based on said determination.

In certain embodiments, the beamforming antenna is a sector antenna implemented as a beamforming antenna. In certain embodiments, the beamforming antenna comprises a plurality of antenna elements to produce a plurality of beams within the sector. In certain embodiments, the mentioned beams are synchronization signal block (SSB) beams.

In certain embodiments, said obtaining samples comprising coordinates of locations within said sector linked with detected information identifying respective beams that served said locations comprises:
obtaining (while each beam of the sector is in use) a sample comprising coordinates of a location within said sector linked with detected information identifying the one beam that served said (particular) location.

In certain embodiments, said obtaining samples comprising coordinates of locations within said sector linked with detected information identifying respective beams that served said locations further comprises:
obtaining (while each beam of the sector is in use) a sample comprising coordinates of another location within said sector linked with detected information identifying the one beam that served said another location.

In certain embodiments, the sample obtaining step is repeated when a (mobile) testing apparatus or device (such as drive test vehicle comprising a mobile terminal or similar) has moved to a new location.

In certain embodiments, the method is performed (samples are obtained) with said sector in its normal operation.

In certain embodiments, said determination comprises determining intended beam directions for each beam and determining whether said detected information complies with said intended beam directions.

In certain embodiments, said determining whether said detected information complies with said intended beam directions comprises:
determining the direction of each sample with respect to a location of the beamforming antenna and comparing that direction to the intended beam direction of the beam in question.

In certain embodiments, said determining whether correct beams served correct locations comprises:
determining from the beams that cover a particular location the one beam that served a mobile testing apparatus of device at that location and determining whether the one beam is the one beam that was intended to serve at that location.

In certain embodiments, a predetermined margin is set to the intended beam directions, and the method comprises determining whether the direction of each sample with respect to a location of the beamforming antenna lies within said margin.

In certain embodiments, the method comprises:
providing output information indicating that the target beamforming antenna is operating incorrectly in the event a pre-determined share of samples or more lies outside of the margin.

In certain embodiments, the incorrect antenna operation is identified as an incorrectly connected radio signal cable or cables.

In certain embodiments, the method comprises:
identifying whether incorrect antenna operation is due to an incorrectly connected radio signal cable, or cables, or due to a misconfigured antenna direction of the beamforming antenna.

In certain embodiments, the method comprises:
determining, for each beam, a median direction at which samples were detected;
comparing, for each beam, the median direction with an intended beam direction; and
providing output information indicating that the direction of the beamforming antenna is incorrect in the event the median direction deviates consistently from the intended beam direction for (or in) all beams.

Accordingly, in certain embodiments, the incorrect antenna operation is determined to be due to an incorrect azimuth angle of the beamforming antenna in the event the median beam directions deviate consistently for all beams.

In certain embodiments, said samples comprise measurement data, for example measured drive test data.

According to a second example aspect of the present invention, there is provided an apparatus, comprising:
a processor; and
a memory including computer program code, the memory and the computer program code being configured, with the processor, to cause the apparatus to perform the method of the first aspect or any related embodiment.

According to a third example aspect of the present invention, there is provided a computer program comprising computer executable program code which when executed by a processor causes an apparatus to perform the method of the first aspect or any related embodiment.

According to a fourth example aspect there is provided a computer program product comprising a non-transitory computer readable medium having the computer program of the third example aspect stored thereon.

According to a fifth example aspect there is provided an apparatus comprising means for performing the method of the first aspect or any related embodiment. Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may 10 be formed into a device without other substantial functions than storing memory or it may be formed as part of a device with other functions, including but not limited to a memory of a computer, a chip set, and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a scenario according to an example embodiment;

FIG. 2 shows a block diagram of an apparatus according to an example embodiment;

FIG. 3 schematically shows operation of a beamforming antenna serving a sector of a cell of a communication network according to an example embodiment;

FIG. 4 schematically shows an example of the beamforming antenna and a related radio module according to an example embodiment;

FIG. 5A schematically shows a correct complete radiation pattern in a four-beam example;

FIG. 5B schematically shows an example radiation pattern in a crossed feeder situation;

FIG. 6A schematically shows samples obtained by a drive test performed within a coverage area of a beamforming antenna in an example case;

FIG. 6B schematically shows a determination of an estimated sector from which samples should be coming for a single beam according to an example embodiment;

FIG. 7 schematically shows an example scenario in which the beamforming antenna is operating incorrectly;

FIG. 8 schematically shows another example scenario in which the beamforming antenna is operating incorrectly;

FIG. 9 shows a flow chart according to an example embodiment; and

FIG. 10 shows a flow chart according to another example embodiment.

### DETAILED DESCRIPTION

In the following description, like reference signs denote like elements or steps.

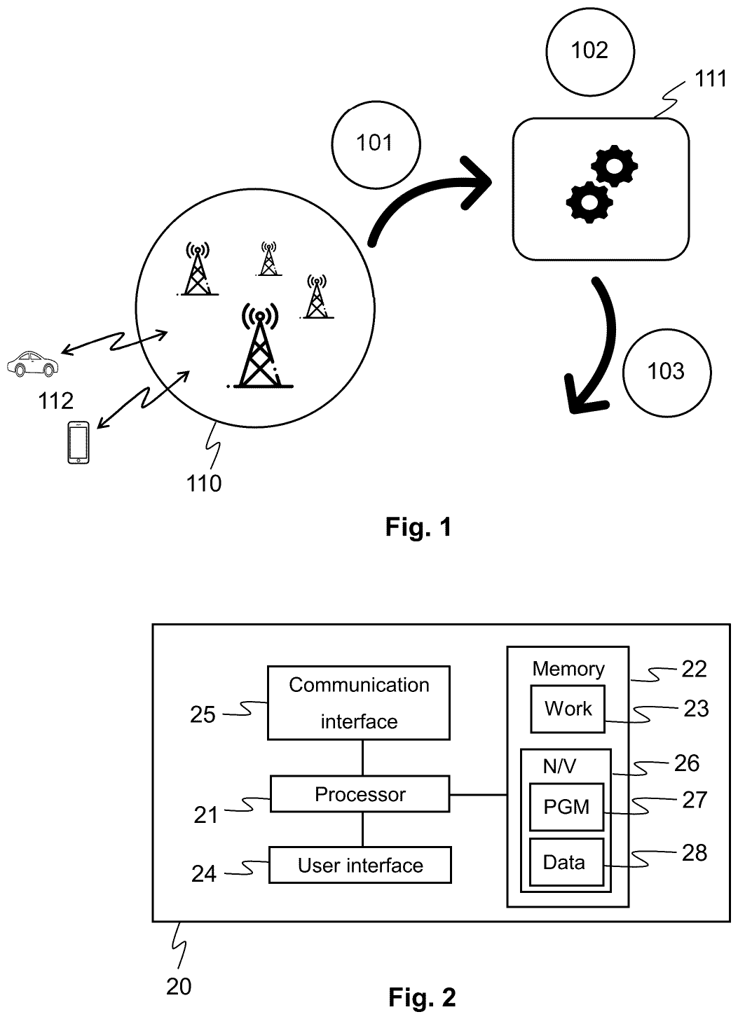

FIG. 1 shows an example scenario according to an embodiment. The scenario shows a communication network 110 serving a plurality of user devices 112 (user equipment, UE) and comprising a plurality of cells and base station sites and other network devices, and an automated system 111 configured to implement recognition of incorrectly operating antennas of the communication network 110.

In an embodiment, the scenario of FIG. 1 operates as follows: In phase 101, the automated system 111 obtains samples containing coordinates of locations and detected information identifying beams serving said locations. These samples may represent for example drive test measurement data sent from a vehicle performing a drive test within a coverage area of a cell or sector. The samples may be communicated locally from a memory or via a cell or cells of base station sites of the network 110.

In phase 102, the automated system 111 uses the received samples to monitor and analyze operation of the cells to detect problems in operation of one or more antennas of the base station sites.

In phase 103, any determined problems are output for further actions such as for example maintenance of the base station sites.

FIG. 2 shows a block diagram of an apparatus 20 according to an embodiment. The apparatus 20 is for example a general-purpose computer or server or some other electronic data processing apparatus. The apparatus 20 can be used for implementing at least some embodiments of the invention. That is, with suitable configuration the apparatus 20 is suited for operating for example as the automated system 111.

The apparatus 20 comprises a communication interface 25, a processor 21, a user interface 24, and a memory 22.

The communication interface 25 comprises in an embodiment a wired and/or wireless communication circuitry, such as Ethernet, Wireless LAN, Bluetooth, GSM, CDMA, WCDMA, LTE, and/or 5G circuitry. The communication interface can be integrated in the apparatus 20 or provided as a part of an adapter, card or the like, that is attachable to the apparatus 20. The communication interface 25 may support one or more different communication technologies. The apparatus 20 may also or alternatively comprise more than one communication interface 25.

The processor 21 may be a central processing unit (CPU), a microprocessor, a digital signal processor (DSP), a graphics processing unit, an application specific integrated circuit (ASIC), a field programmable gate array, a microcontroller or a combination of such elements.

The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 comprises a work memory 23 and a persistent (non-volatile, N/V) memory 26 configured to store computer program code 27 and data 28. The memory 26 may comprise any one or more of: a read-only memory (ROM), a programmable read-only memory (PROM), an erasable programmable read-only memory (EPROM), a random-access memory (RAM), a flash memory, a data disk, an optical storage, a magnetic storage, a smart card, a solid state drive (SSD), or the like.

The apparatus 20 may comprise a plurality of memories 26. The memory 26 may be constructed as a part of the apparatus 20 or as an attachment to be inserted into a slot, port, or the like of the apparatus 20 by a user or by another person or by a robot. The memory 26 may serve the sole purpose of storing data, or be constructed as a part of an apparatus 20 serving other purposes, such as processing data.

A skilled person appreciates that in addition to the elements shown in FIG. 2, the apparatus 20 may comprise other elements, such as microphones, displays, as well as additional circuitry such as an input/output (I/O) circuitry, memory chips, application-specific integrated circuits (ASIC), a processing circuitry for specific purposes such as a source coding/decoding circuitry, a channel coding/decoding circuitry, a ciphering/deciphering circuitry, and the like. Additionally, the apparatus 20 may comprise a disposable or rechargeable battery (not shown) for powering the apparatus 20 when external power if external power supply is not available.

Further, it is noted that only one apparatus is shown in FIG. 2, but the embodiments of the invention may equally be implemented in a cluster of shown apparatuses.

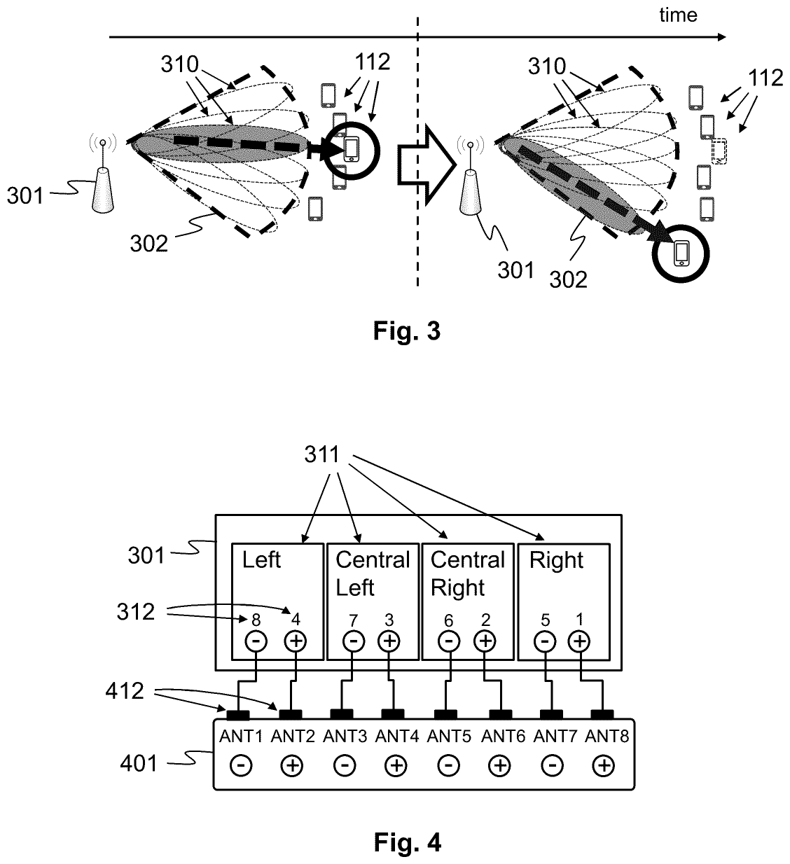

FIG. 3 schematically shows operation of a beamforming antenna serving a sector of a cell of a communication network according to an example embodiment. The transmission of data and control information to any individual user device 112 (such as a smart phone or another mobile communication device) is done with the aid of narrow beams. Each individual beam is a signal limited in space (narrow beam) intended to reach a certain user device (or devices) 112 located within the coverage area of that specific beam. In the example shown in FIG. 3, there are six beams 310 formed by a beamforming antenna 301 that serves the sector 302 of a cell of a mobile communication network (in other embodiments, the number of beams may vary). In the leftmost drawing of the example, the user device 112 that is marked with a black circle is within the coverage of the third beam 310 calculated from the left, and in the rightmost drawing that presents a situation after a period of time has passed, the user device 112 in question has moved into the coverage of the rightmost beam 310.

FIG. 4 schematically shows an example of the beamforming antenna 301 and a related radio module 401 (a remote radio unit). The beamforming antenna 301 comprises a plurality of antenna elements 311. The beamforming antenna 301 further comprises a plurality of antenna ports 312 in each of the elements 311. In the example shown in FIG. 4, the number of antenna elements (which is also the number of beams) is four. However, as has been already described in the preceding, the number of antenna elements varies between different embodiments. Similarly, the number of antenna ports 312 is two for each of the elements 311. The radio module comprises a plurality of output ports 412 to be connected to respective antenna ports 314 by cables (radio signal cables). In the example shown in FIG. 4, the correspondence of the output ports 412 and the antenna ports 312, is as follows:

| Output port | Antenna port |
|---|---|
| ANT1 | 8 |
| ANT2 | 4 |
| ANT3 | 7 |
| ANT4 | 3 |
| ANT5 | 6 |
| ANT6 | 2 |
| ANT7 | 5 |
| ANT8 | 1 |

In this example, this represents a correct cabling, whereas if any of the two or more cables are not connected as shown in the preceding table, there is a crossed feeder situation (i.e., an incorrect cabling).

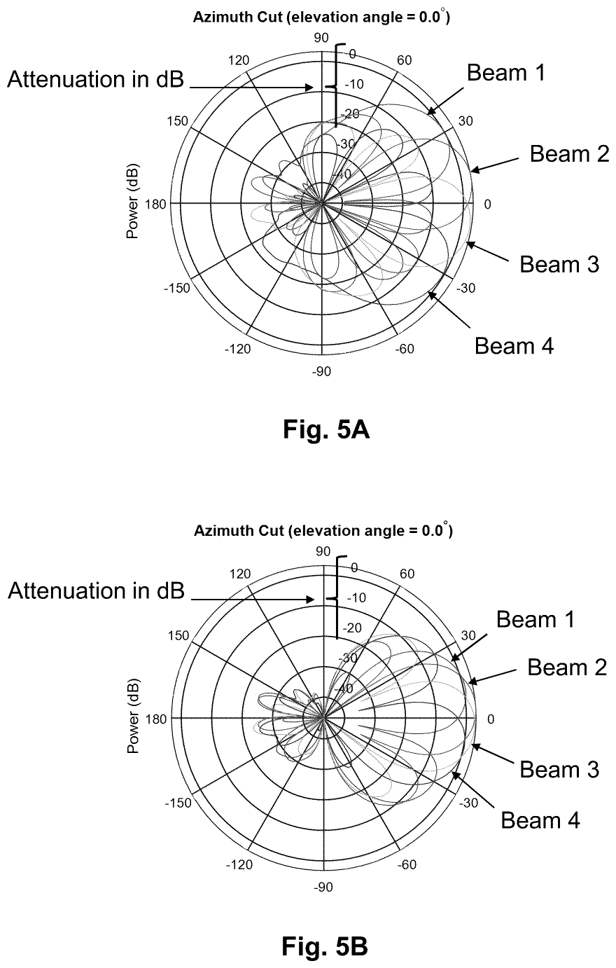

FIG. 5A schematically shows an example of a complete radiation pattern (beam power depending on direction) in such a four-beam example where the cables are correctly connected, whereas FIG. 5B shows the radiation pattern in an example in which cables are crossed (i.e., in the case of an incorrect cabling).

When the obtained power is compared, it is observed that there is a significant drop in the obtained power in FIG. 5B in the edge areas, which will result in less sharp beams and antenna coverage losses.

In order to recognize incorrect operation of a beamforming antenna, embodiments of the invention provide crossed feeder detection in beam forming sectors using coordinate-based location data. This data or samples may be obtained from (vehicle) drive tests that are regularly performed.

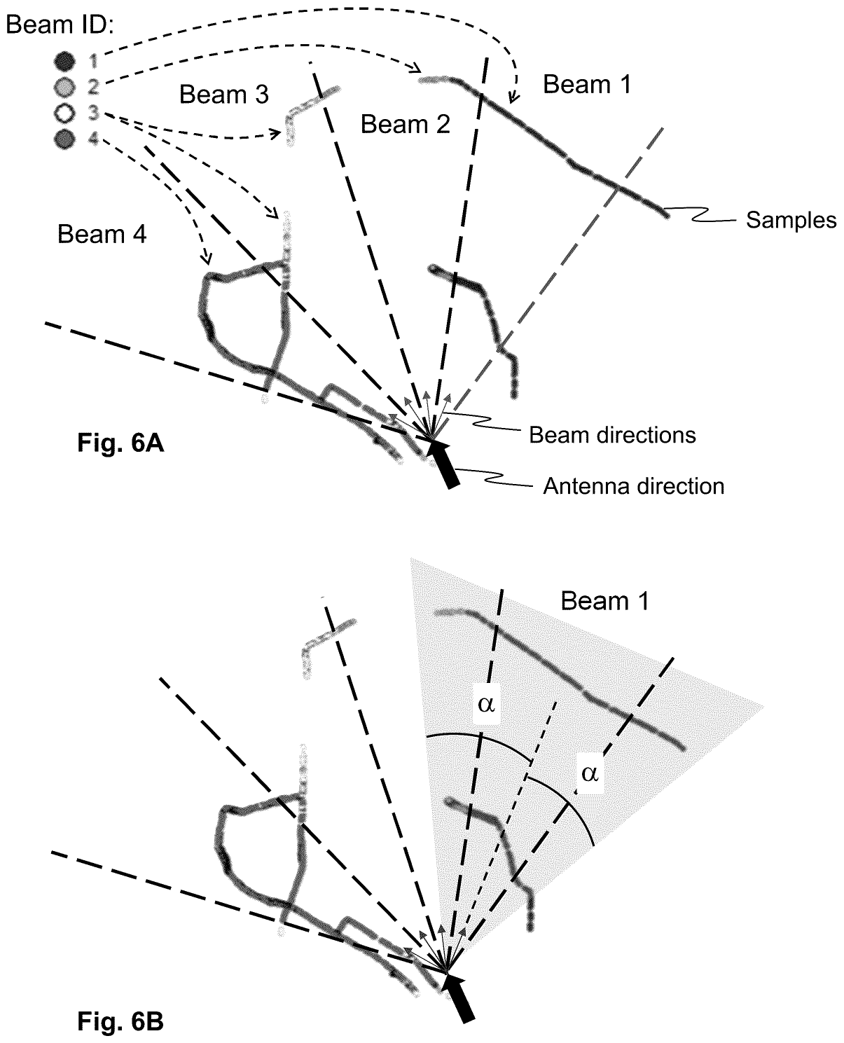

FIG. 6A schematically shows samples obtained by a drive test performed within a coverage area of the beamforming antenna 301 in an example case in which the beamforming antenna 301 operates correctly. In this example case, the beamforming antenna is in the direction of 340°, the number of beams of the beamforming antenna 301 is four, identified by beam IDs 1 to 4, and the estimated directions of the beams 1 to 4 are 10°, 350°, 330°, and 310°, respectively. The straight lines between beams in the figure depict theoretical split points of (adjacent) beams. As is noted from FIG. 6A, when the beamforming antenna 301 operates correctly, correct beams serve correct locations. In other words, the beam 1 receives samples mainly from the coverage area or sector it is intended to serve, the beam 2 from an adjacent sector, and so on.

FIG. 6B schematically shows a determination of an intended coverage area or sector from which samples should be coming for a single beam (here: Beam 1) according to an example embodiment. The following directions are determined:

$$beam direction - α$$

$$beam direction + α ,$$

where α is a maximum deviation, in degrees, from the intended (theoretical) beam (central) direction i.e. the “beam direction”. The area bounded by the directions beam direction −α and beam direction +α is defined as the intended coverage area. Samples should normally be coming from directions ranging from beam direction −α to beam direction +α, whereas samples coming from other directions (and therefore outside of the intended coverage area) are considered abnormal samples. For Beam ID 1, the intended coverage area is highlighted in FIG. 6B. Depending on the selection of α, the intended coverage area may extend over the theoretical split points.

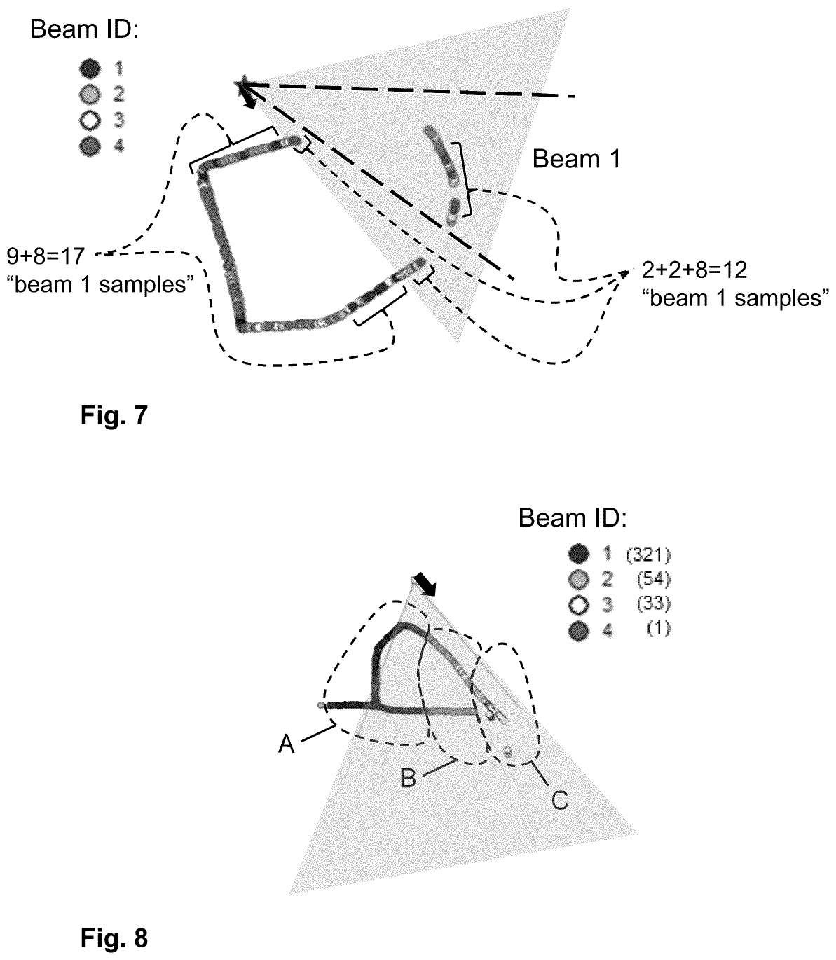

FIG. 7 schematically shows an example scenario in which the beamforming antenna 301 is operating incorrectly. Only 12 samples of a total of 29 samples having Beam ID 1 are coming from the intended coverage area. Accordingly, over 50% of the samples are abnormal samples, which clearly indicates that the beamforming antenna 301 is operating incorrectly (crossed feeder configuration).

FIG. 8 schematically shows another example scenario in which the beamforming antenna is operating incorrectly. In this example, the samples are logically received as expected but the areas from which samples are coming (area A for beam 1 samples, area B for beam 2 samples, and area C for beam 3 samples) consistently deviate from intended beam directions. This kind of behavior indicates a configuration error in the direction of the beamforming antenna 301. The highlighted area in FIG. 8 is the intended coverage area from which samples should be coming for beam 1.

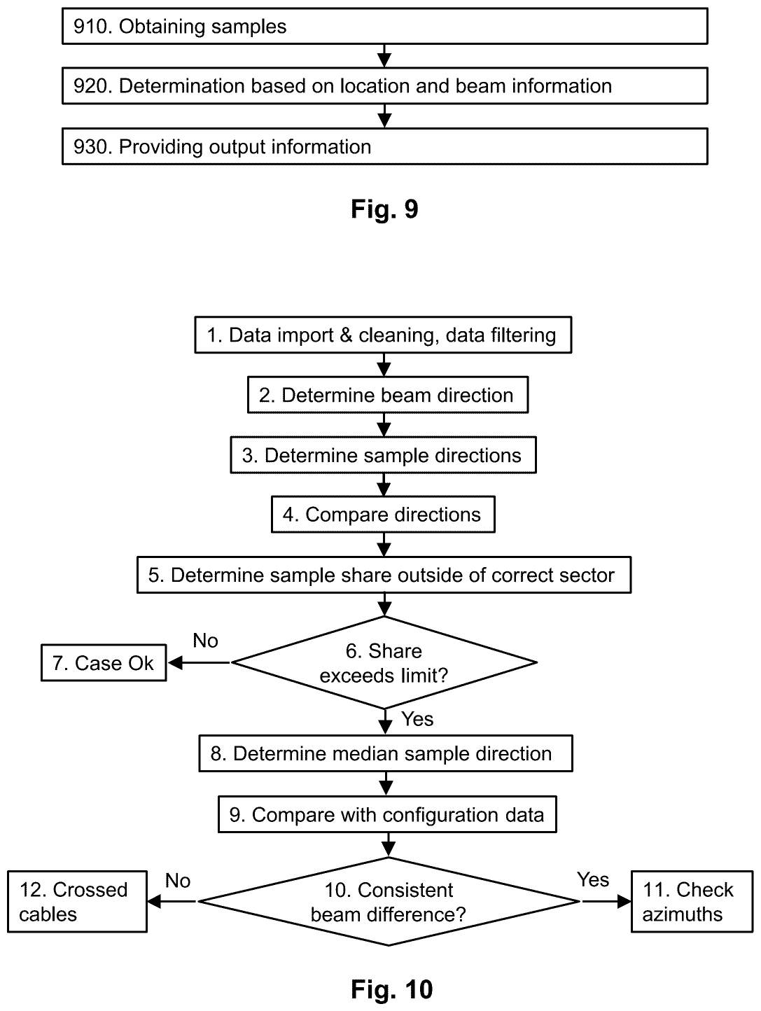

FIG. 9 shows a flow chart according to an example embodiment. In phase 910 samples or a data set comprising coordinates of locations within a sector of a cell of a communication network linked with detected information identifying respective beams that served said locations are obtained. The samples are obtained locally or over a network. The coordinates may be GPS coordinates. The information identifying respective beams may be beam IDs. The samples or a data set may be drive test data.

In phase 920 it is determined whether correct beams serve correct locations. In certain embodiments, this is performed for example based on comparing directions from which samples are received with the respective beam (central) direction, the respective beam being identified by the beam ID.

In phase 930 output information indicating whether the beamforming antenna is operating incorrectly is provided based on said determination. For example, a share of abnormal samples (i.e. samples coming from too oblique directions) is calculated and compared with a predetermined threshold in certain embodiments. And a conclusion of the operational correctness of the beamforming antenna is drawn based on the comparison.

FIG. 10 shows a flow chart of a more detailed embodiment. In phase 1, measurement samples or a data set comprising said samples is imported into the system 111. Each sample contains information on location coordinates and an identifier identifying the beam serving at said location. Certain data cleaning, for example removal of samples from an exactly same location may be optionally performed. Furthermore, certain non-representative samples, such as samples from a back lobe of the antenna 301 may be filtered out.

In phase 2, the direction of each beam (i.e. intended beam central direction) of the beamforming antenna 301 is determined. In certain embodiments, this means a theoretical beam direction calculation of each beam. In certain embodiments, the calculation is performed based on the antenna bearing and the number of beams as depicted in connection with FIG. 6A in the preceding.

In phase 3, the direction of each measurement sample is determined. The direction of each sample is calculated with respect of (or from) the location of the beamforming antenna 301. In certain embodiments, the direction of each sample is calculated based on the latitude and longitude of each sample and the latitude and longitude of the beamforming antenna 301.

In phase 4, the direction of each measurement sample is compared with the respective beam direction (i.e. direction of the beam serving at the location of the sample in question as identified by the beam ID) to obtain a difference between the sample direction and the respective beam direction. The comparison may be performed by a simple subtraction.

In phase 5, for each beam, the share of measurement samples that reside outside of the intended coverage area of the respective beam is determined. The intended coverage area may be defined similarly as presented in connection with FIG. 6B so that samples coming from directions between beam direction −α and beam direction +α represent samples within the coverage area and samples coming from the outside of this sector represent outside samples. The maximum (angular) deviation a may be selected depending on the embodiment. It represents a predetermined margin set to the (intended) beam directions, and the method comprises determining whether the direction of each sample with respect to the location of the beamforming antenna lies within said margin.

In certain embodiments, the maximum deviation a is set to 30°. The intended coverage area then appears as a 60° sector. In a practical embodiment, the differences calculated in phase 4 are put into two bins: BIN1 for samples for which |difference|≤α; and BIN2 for samples for which |difference|>α. The share of samples belonging to BIN2 with respect to the total number of samples is calculated: #BIN2/(#BIN1+#BIN2), where #BIN1 is the number of samples belonging to BIN1 and #BIN2 is the number of samples belonging to BIN2.

In phase 6, it is determined whether the share of outside samples exceeds a predetermined limit, for example 10%. If this is not the case, it is concluded in phase 7 that the share of outside samples represents a normal case. However, if the share of outside samples exceeds the predetermined limit, it is concluded that the beamforming antenna 301 operates incorrectly.

Phases 8 to 12 will now optionally be performed to determine the reason for the incorrect operation. In phase 8, a median sample direction (or direction of the median sample) is determined for each beam (as identified by the beam ID). In phase 9, the median sample direction is compared with configuration data. In certain embodiments, the comparison is performed by comparing the median sample direction with a respective beam direction (intended or theoretical beam central direction for each beam). The comparison may be performed by a simple subtraction to obtain a difference. If the difference is consistent over each of the beams (phase 10: a corresponding or consistent difference in each beam, with a certain level of accuracy, e.g. 10°), it is concluded in phase 11 that the incorrect operation is due to a misconfigured antenna direction of the beamforming antenna 301. If the difference is not consistent, it is concluded in phase 12 that the incorrect operation is due to an incorrectly connected radio signal cable, or cables. The conclusion is provided as output information.

Without limiting the scope and interpretation of the patent claims, certain technical effects of one or more of the example embodiments disclosed herein are listed in the following. A technical effect is providing an automated method for recognizing incorrectly operating beamforming antennas of a cellular communication network. In this way, improved network monitoring may be provided based on coordinate-based location data.

Various embodiments have been presented. It should be appreciated that in this document, words comprise, include and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A computer implemented method for recognizing an incorrectly operating beamforming antenna that serves a sector of a cell of a communication network, the method comprising:
obtaining samples comprising coordinates of locations within said sector linked with detected information identifying respective beams that served said locations;
determining whether correct beams served correct locations; and
providing output information indicating whether the beamforming antenna is operating incorrectly based on said determination.

2. The method of claim 1, wherein said determination comprises determining intended beam directions for each beam and determining whether said detected information complies with said intended beam directions.

3. The method of claim 2, wherein said determining whether said detected information complies with said intended beam directions comprises:
determining the direction of each sample with respect to a location of the beamforming antenna and comparing that direction to the intended beam direction of the beam in question.

4. The method of claim 2, wherein a predetermined margin is set to the intended beam directions, and the method comprises determining whether the direction of each sample with respect to a location of the beamforming antenna lies within said margin.

5. The method of claim 4, comprising:
providing output information indicating that the target beamforming antenna is operating incorrectly in the event a pre-determined share of samples or more lies outside of the margin.

6. The method of any preceding claim 1, comprising:
identifying whether incorrect antenna operation is due to an incorrectly connected radio signal cable, or cables, or due to a misconfigured antenna direction of the beamforming antenna.

7. The method of claim 6, comprising:
determining, for each beam, a median direction at which samples were detected;
comparing, for each beam, the median direction with an intended beam direction; and
providing output information indicating that the direction of the beamforming antenna is incorrect in the event the median direction deviates consistently from the intended beam direction for all beams.

8. The method of claim 1, wherein said samples comprise measured drive test data.

9. The method of claim 1, wherein the beamforming antenna is a sector antenna of a fifth generation, 5G, or a further generation mobile communication network.

10. An apparatus, comprising:
a processor; and
a memory including computer program code, the memory and the computer program code being configured, with the processor, to cause the apparatus to perform the method claim 1.

11. A computer program comprising computer executable program code which when executed by a processor causes an apparatus to perform the method of claim 1.

12. The method of claim 3, wherein a predetermined margin is set to the intended beam directions, and the method comprises determining whether the direction of each sample with respect to a location of the beamforming antenna lies within said margin.

13. The method of claim 2, comprising: identifying whether incorrect antenna operation is due to an incorrectly connected radio signal cable, or cables, or due to a misconfigured antenna direction of the beamforming antenna.

14. The method of claim 3, comprising: identifying whether incorrect antenna operation is due to an incorrectly connected radio signal cable, or cables, or due to a misconfigured antenna direction of the beamforming antenna.

15. The method of claim 4, comprising: identifying whether incorrect antenna operation is due to an incorrectly connected radio signal cable, or cables, or due to a misconfigured antenna direction of the beamforming antenna.

16. The method of claim 5, comprising: identifying whether incorrect antenna operation is due to an incorrectly connected radio signal cable, or cables, or due to a misconfigured antenna direction of the beamforming antenna.

17. The method of claim 2, wherein said samples comprise measured drive test data.

18. The method of claim 3, wherein said samples comprise measured drive test data.

19. The method of claim 4, wherein said samples comprise measured drive test data.

20. The method of claim 5, wherein said samples comprise measured drive test data.
